(19) United States
(12) Patent Application Publication
(10) Pub. No.: US 2006/0281566 A1
(43) Pub. Date: Dec. 14, 2006

(54) Flexible transmission shaft

(76) Inventor: Man Soo Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 10/573,806

(22) PCT Filed: Jun. 18, 2005
(86) PCT No.: PCT/KR05/01898

§ 371 Date: Mar. 28, 2006

(30) Foreign Application Priority Data
Jun. 25, 2004 (KR) 10-2004-0048062

(51) Int. Cl. F16D 3/18

(52) U.S. Cl. 464/149

(57) ABSTRACT

Provided is a flexible transmission shaft. The flexible transmission shaft for transmitting a torque from a drive source to a driven load, the flexible transmission shaft includes a pipe-shaped shaft, which has one or more slits extending in a circumferential direction of the shaft, each of the slits having two opposed surfaces that are isolated from each other by the slit, a plurality of protrusions protruding from one of the opposed surfaces, and a plurality of recessions formed in the other one of the opposed surfaces to receive and support the protrusions therein. Since the flexible transmission shaft can be bent or curved within a given angle, it can be substituted for a flexible coupling, a universal joint, or a bevel gear. In addition, the flexible transmission shaft does not require additional mechanical elements to be connected to a shaft, and has a simple structure, light weight, and high torque transmission capability.

### TECHNICAL FIELD

The present invention relates to a flexible transmission shaft used for transmitting torque.

### BACKGROUND ART

A variety of shaft couplings are used for transmitting a torque from a drive shaft to a driven shaft. In particular, when the axis of rotation of the drive shaft and the axis of rotation of the driven shaft are different from each other, for example, when they are parallel to or intersect each other, the two shafts are connected using a flexible coupling or a universal joint.

Flexible couplings are used to connect two shafts which are not coaxial and thus the shafts and bearings are subjected to higher loads and might vibrate. That is, flexible couplings allow misalignment between the axes of rotation to some extend. Although the flexible couplings have advantageous features, most of them do not have a high torque transmission capability.

Universal joints are used to connect two shafts whose axes of rotation intersect at an angle of about 30 degrees or less. The universal joints have a cross-shaped pin that is interposed between two shafts and the two shafts are respectively connected to the cross-shaped pin.

### DISCLOSURE OF THE INVENTION

### Technical Problem

However, the conventional shaft couplings require a plurality of mechanical elements to be connected to the shafts. For example, the flexible couplings require a rubber shaft, a rubber sprocket, a chain, a rubber coupling, a leader pelt, a spring axis, or fastening means such as bolts and nuts according to coupling methods. Accordingly, the conventional flexible couplings are complex and heavy, difficult to assembly, and need to be frequently maintained and repaired. Further, the cross-shaped pin of the universal joints can easily break contrary to many expectations.

### Technical Solution

The present invention provides a flexible transmission shaft that can be substituted for, for example, a flexible coupling, a universal joint, or a bevel gear since it can be bent or curved within a given angle, and has a simple structure, light weight, and high torque transmission capability.

### Advantageous Effects

Since the flexible transmission shaft of the present invention can be bent or curved within a given angle, the flexible transmission shaft can be substituted for, for example, a flexible coupling, a universal joint, or a bevel gear. In addition, the flexible transmission shaft does not require additional mechanical elements to be connected to a shaft, and has a simple structure, light weight, and high torque transmission capability. And the flexible transmission shaft of the present invention can be used, for example, in the automobile industry or aviation industry in cases where torques must be transmitted to different parts hardly accessible due to bundle wires or various manifold.

### DESCRIPTION OF THE DRAWINGS

FIG. 1 is a perspective view of a flexible transmission shaft according to an embodiment of the present invention.

FIGS. 2A and 2B are enlarged views of essential parts of the flexible transmission shaft of FIG. 1.

FIG. 3 illustrates a state where the flexible transmission shaft of FIG. 1 is bent.

FIG. 4 is a sectional view taken along line IV-IV of FIG. 2A,

FIG. 5A illustrates an example of shortening and using the flexible transmission shaft of FIG. 1 as a flexible joint.

FIG. 5B illustrates an example of using the flexible transmission shaft of FIG. 1.

FIG. 6 illustrates another example of using the flexible transmission shaft of FIG. 1.

FIG. 7 illustrates another example of modifying and using the flexible transmission shaft of FIG. 1.

FIGS. 8A and 8B are perspective views illustrating state examples of modifying and using the flexible transmission shaft of the present embodiment as a tightening tool.

FIG. 9 is a partial perspective view of a flexible transmission shaft according to anther embodiment of the present invention.

FIG. 10 illustrates a state where the flexible transmission shaft of FIG. 9 is bent.

FIGS. 11 and 12 illustrate examples of using the flexible transmission shaft of FIG. 9.

FIGS. 13A and 13B are partial views of the flexible transmission shaft of the present invention having slits of different pattern.

### BEST MODE

The present invention will now be described more fully with reference to the accompanying drawings, in which preferred embodiments of the invention are shown.

The present invention basically relates to a hollow pipe having one or more slits. The slits extend along a circumferential direction of the pipe in a predetermined pattern such that the pipe can be bent.

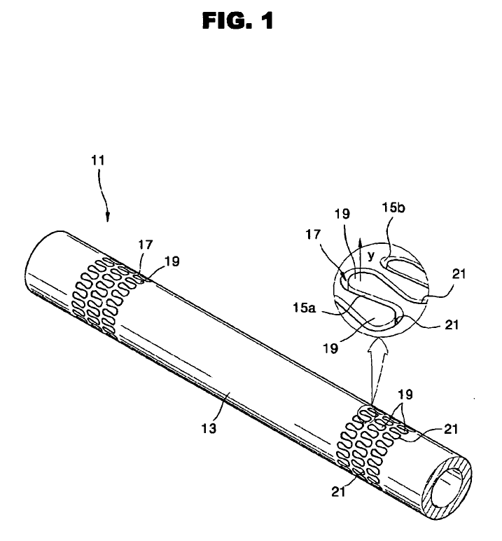

FIG. 1 is a perspective view of a flexible transmission shaft according to an embodiment of the present invention.

Referring to FIG. 1, a flexible transmission shaft 11 includes a pipe 13 having a plurality of slits 17. The slits 17 are formed in the pipe 13 using an ordinary laser cutter or a water jet.

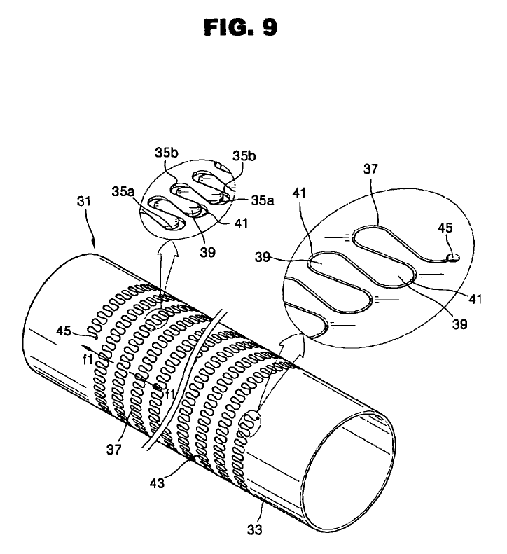

The width of the slits 17 and a slit 37 shown in FIG. 9 is determined when the slits 17 and 37 are processed. The width of the slits 17 and 37 is a chief factor in determining the degree to which the pipes 13 and 3 1 are bent, and thus the slits 17 and 37 are designed to have proper widths according to needs.

Each of the slits 17 has a repeated ‘S’ pattern and completely circles the pipe 13 such that ends of the slit 17 meet each other. Accordingly, the left portion and the right portion of the slit 17 are divided and isolated from each other. Further, since the slits 17 have a predetermined width as described above, the pipe 13 can move within a range of the width.

Although six slits 17 are separately located in two groups of three slits 17 in FIG. 1, the number and positions of the slits 17 can be different. For example, a plurality of slits may be formed in a longitudinal direction of the pipe 13 at regular intervals or at irregular intervals, or only one slit may be formed.

Since the slits 17 have the continuous ‘S’ pattern, protrusions 19 and recessions 21 are formed on opposite surfaces 15a and 15b of the left portion and the right portion which are parted by the slit 17 and opposed each other.

The protrusions 19 are formed on one opposite surface 15a and protrude toward the other opposite surface 15b that faces the one opposite surface 15a. As the protrusions 19 extend toward the other opposite surface 15b, the width of the protrusions 19 increases and front ends of the protrusions become round.

The recessions 21 receive and support the protrusions 19 therein. The recessions 21 have a gourd shape such that they have a width increasing toward the inside thereof and decreasing toward an inlet. Accordingly, the recessions 21 can prevent the protrusions 19 supported therein from being separated therefrom.

In particular, since the slits 17 are formed along the circumferential direction of the cylindrical pipe 13, the protrusions 19 cannot be lifted in a direction marked by arrow y from the recessions 21. Accordingly, as long as the recessions 21 retain the protrusions 19 therein, the pipe 13 is not disassembled.

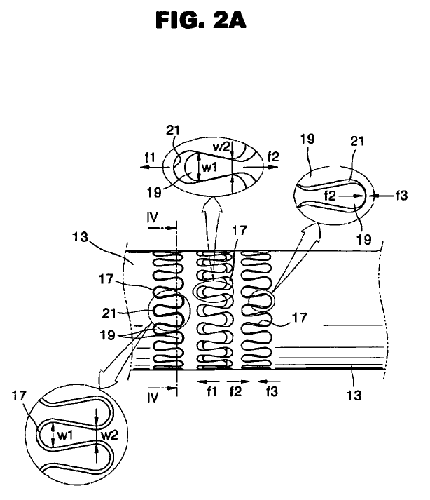

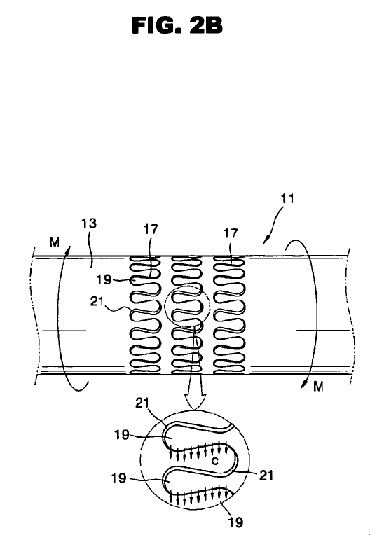

FIGS. 2A and 2B are enlarged views illustrating essential parts of the flexible transmission shaft of FIG. 1. For the convenience of explanation, portions of the pipe 13 divided by a central slit 17 are extended in directions marked by arrows f1 and f2, and portions of the pipe 13 divided by a right slit 17 are pressed in directions marked by arrows f2 and f3. Portions of the pipe 13 divided by a left slit 17 are not extended nor pressed.

Referring to FIG. 2A, a maximum width w1 of the protrusions 19 is greater than a minimum width w2 of the recessions 21 at the inlet side. Accordingly, although the portions of the pipe 13 with the central slit 17 therebetween are pulled in the directions marked by arrows f1 and f2, the opposite surface 15a of the protrusions 19 is caught by the opposite surface 15b of the recessions 21 such that the protrusions 19 are prevented from being separated from the recessions 21.

In contrast, when the portions of the pipe 13 with the right slit 17 therebetween are pressed in the directions marked by arrows f2 and f3, the protrusions 19 can move in the recessions 21 until the front end of the protrusions 19 reach the deepest part of the recessions 21.

When a torque M is applied to both ends of the pipe 13 as sown in FIG. 2B, the protrusions 19 respectively move to a side of the recessions 21 to press the opposite surface 15b of the recessions 21 in a direction marked by c. Consequently, the torque applied to one end of the pipe 13 can be transmitted to the other end of the pipe 13.

The protrusions 19 can move in the recessions 21 because the slits 17 have a pre-determined width. That is, the width of the slits 17 allows adjacent portions of the pipe 13 with the slits 17 therebetween to relatively move to each other.

When the width of the slits 17 increases up to the extend where the recessions 21 can retain the protrusions 19 therein, relative movements of the adjacent portions of the pipe 13 increase and a maximum angle at which the transmission shaft can be bent increases as well.

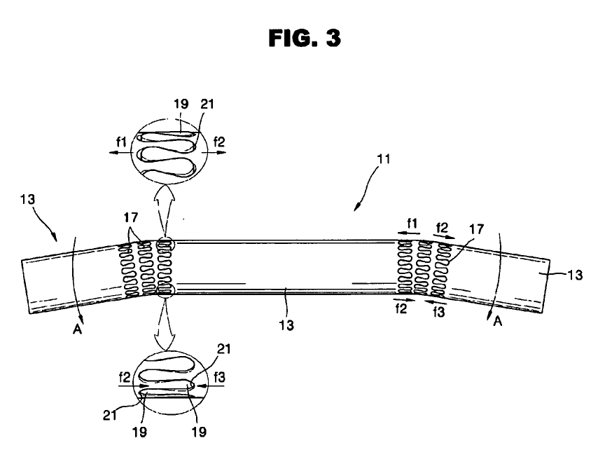

FIG. 3 illustrates a state where a bending torque is applied to both ends of the flexible transmission shaft of FIG. 1 in a direction marked by arrow A.

In this case, a tension force is applied to the outer side of the pipe 13 in directions marked by arrows f1 and f2 and a compression force is applied to the inner side of the pipe 13 in directions marked by arrows f2 and f3.

Due to the tension force applied in the directions marked by arrows f1 and f2 as shown in FIG. 2A, the protrusions 19 respectively stretch out to the maximum from the recessions 21. Due to the compression force applied in the directions marked by arrows f2 and f3, the protrusions 19 respectively travel into the deep part of the recessions 21, and finally the pipe 13 has a bent shape.

Particularly, since each of the protrusions 19 can move in each of the recessions 21, when the bent transmission shaft 11 is supported by a bearing (not shown), a drive shaft and a driven shaft are connected to both ends of the pipe 13, and the drive shaft is rotated, the transmission shaft 11 transmits a torque in the state of being bent.

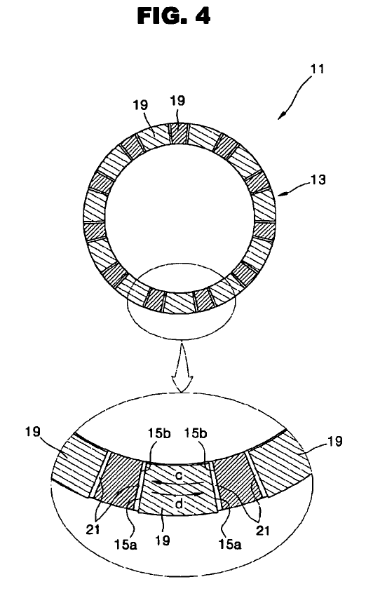

FIG. 4 is a cross-sectional view taken along line IV-IV of FIG. 2A.

Referring to FIG. 4, the protrusions 19 are respectively accommodated in the recessions 21. The opposite surface 15b of the recessions 21 faces the opposite surface 15a of the protrusions 19 respectively received in the recessions 21. Accordingly, if a rotational torque is applied to one end of the transmission shaft 11, the protrusions 19 move in a direction marked by c or d in the recessions 21, and the opposite surface 15a of the protrusions 19 presses the opposite surface 15b of the recessions 21 to transmit power.

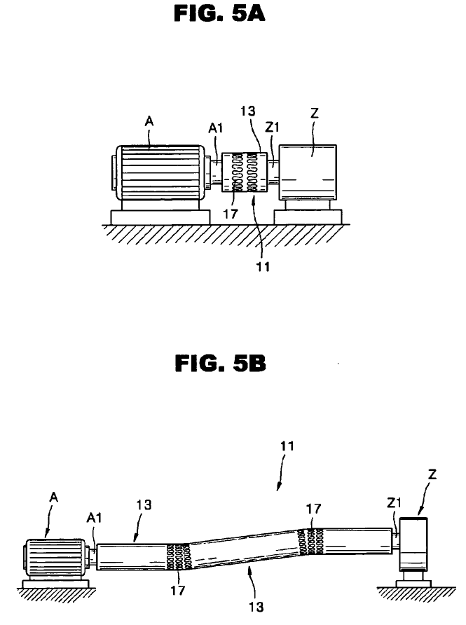

FIG. 5A illustrates an example of shortening and using the flexible transmission shaft of FIG. 1 as a flexible joint.

Referring to FIG. 5A, a drive source A and a driven load Z are located near each other to face each other, and a drive shaft A1 and a driven shaft Z1 are connected by the short flexible transmission shaft 11. Further, two slits 17 are formed in the pipe 13 of the shaft 11.

Accordingly, even if the axes of rotation of the drive shaft A1 and the driven shaft Z1 are different, power can be transmitted without any vibration accruing from the shafts A1 and Z1 or the shaft bearings (not sown) so long as the flexible transmission shaft 11 can be bent.

It is actually difficult to have the drive shaft and driven shaft ideally aligned with each other, and misalignment usually occurs due to thermal expansion in motion and wear of the bearings even though the axes of rotation had been aligned. Those problems can be simply solved by using the flexible transmission shaft 11 of the present embodiment.

FIG. 5b illustrates an example of using the flexible transmission shaft of FIG. 1.

Referring to FIG. 5B, the flexible transmission shaft 11 connects a drive source A and a driven load Z. In particular, a drive shaft A1 of the drive source A and a driven shaft Z1 of the driven load Z are parallel to each other. To couple the shafts A1 and Z1, the flexible transmission shaft 11 can be used instead of a conventional universal joint.

As described above, since the flexible transmission shaft 11 of the present embodiment can transmit a torque while being bent, it can be substituted for the conventional universal joint.

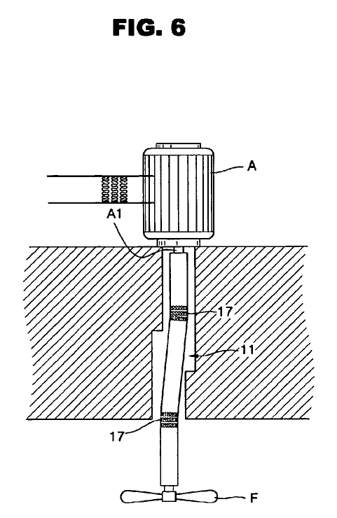

FIG. 6 illustrates another example of using the flexible transmission shaft of FIG. 1.

Referring to FIG. 6, an upper end of the flexible transmission shaft 11 is fixed to the drive shaft A1, and a fan F is disposed on a lower end of the flexible transmission shaft 11.

Since the protrusions 19 respectively inserted into the recessions 21 are prevented from being separated from the recessions 21, although the transmission shaft 11 is in a vertical position, the flexible transmission shaft 11 is not disassembled and the fan F can be rotated. Furthermore, the transmission shaft 11 can be kept in the bent state using a bearing (not shown).

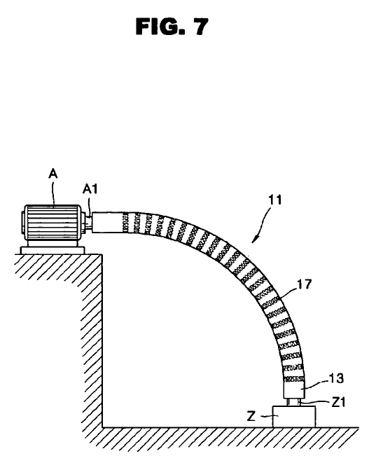

FIG. 7 illustrates another example of modifying and using the flexible transmission shaft of FIG. 1.

Referring to FIG. 7, a plurality of slits are formed in a longitudinal direction of the pipe 13 at regular intervals. Accordingly, the pipe 13 can be bent round like a well-known flexible shaft.

Accordingly, although the rotation axes of a drive shaft A1 and a driven shaft Z1 intersect each other at an angle of 90 degrees, the drive shaft A1 and the driven shaft Z1 can be coupled using only the flexible transmission shaft 11 of the present embodiment.

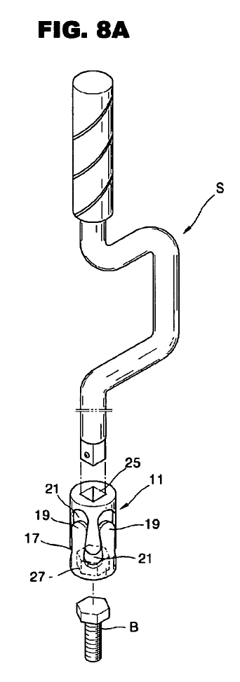

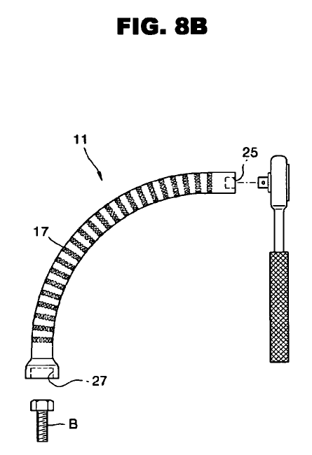

FIGS. 8A and 8B illustrate state examples of modifying and using the flexible transmission shaft of the present embodiment as a tightening tool.

Referring to FIG. 8A, the flexible transmission shaft 11 may be used as a joint socket by forming a square groove 25, into which a wrench (e.g., a speed handle) is inserted, on an upper end of the flexible transmission shaft 11, and an insertion groove 27, in which the head of a bolt B is received, on a lower end of the flexible transmission shaft 11.

In case of a conventional joint socket, since a force is mainly applied on a linking pin, the linking pin is easily broken. When the flexible transmission shaft 11 is used as a joint socket, however, the flexible transmission shaft 11 is barely damaged. The square groove 25 and the insertion groove 27 have predetermined sections along the longitudinal direction of the shaft 11.

FIG. 8B illustrates an example where a square groove 25 is formed on an upper end of a longitudinally extended transmission shaft 11, and an insertion groove 27 is formed on a lower end of the longitudinally extended flexible transmission shaft 11.

The flexible transmission shaft 11 of FIG. 8B is longer than that of FIG. 8A. Thus, even though certain bolts or nuts of a so-to-speak automobile or an airplane which behind wire bundles or various manifolds and it is difficult to tighten or loosen the bolts or nuts using a wrench, the flexible transmission shaft can reach the bolts or nuts.

FIG. 9 is a partial perspective view of a flexible transmission shaft according to another embodiment of the present invention.

Referring to FIG. 9, a slit 37 is formed in a pipe 33. The slit 37 spirally extends in a longitudinal direction of the pipe 33. While the slit 17 circles the circumference of the pipe 13 and ends thereof meet such that adjacent portions of the pipe 13 are completely isolated by the slit 17, the slit 37 extends spirally along the pipe 33.

Thus, ends of the slit 37 do not meet and are located on the opposite sides of the pipe 33. Stopping holes 45 are formed in both ends of the slit 37 to prevent a crack growing from the ends of the slit 37.

In the meantime, the slit 37 also has such a continuous ‘S’ pattern as shown in FIG. 1. Accordingly, protrusions 39 and recessions 41 are formed at adjacent portions of the pipe 33 with the slit 37 therebetween. The shape and function of the protrusions 39 and the recessions 41 are the same as those of FIG. 1.

Further, since the slit 37 has a predetermined width, an opposite surface 35a of the protrusions 39 and the other opposite surface 35b of the recessions 41 are spaced by the width of the slit 37, and the opposite surfaces 35a and 35b can move forward or backward. Accordingly, when the pipe 33 is pulled in a direction marked by arrow f1, the protrusions 39 slightly stretch out from the recessions 41 to increase the entire length of the pipe 33 until the opposite surface 35a of the protrusions 39 is caught by the opposite surface 35b of the recessions 41.

FIG. 10 illustrates a state when the flexible transmission shaft of FIG. 9 is generally bent.

Referring to FIG. 10, since the spiral slit 37 is distributed over the almost entire surface of the pipe 33, if the transmission shaft 31 is upwardly bent, the entire transmission shaft 31 can be bent since the outer portion of the flexible transmission shaft 31 is widened in a direction marked by arrow f1 and the inner portion of the flexible transmission shaft 31 is contracted in a direction marked by f2.

The degree to which the transmission shaft 31 is bent can be adjusted by changing the width of the slit 37. For example, the width of the slit 37 is wider, the pipe 33 can be more spread out in the direction marked by f1 and can be more contracted in the direction marked by arrow f2, thereby increasing the curvature of the transmission shaft 31.

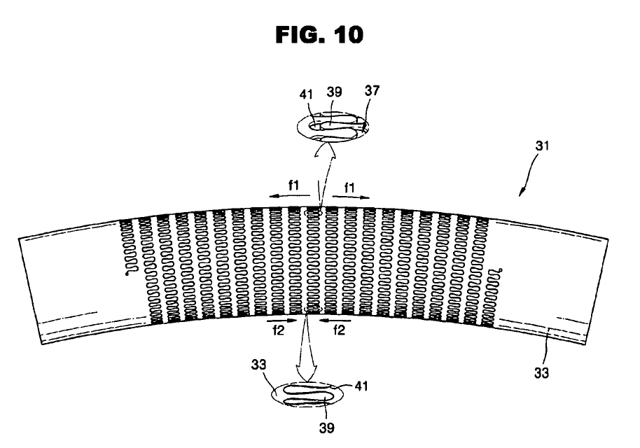

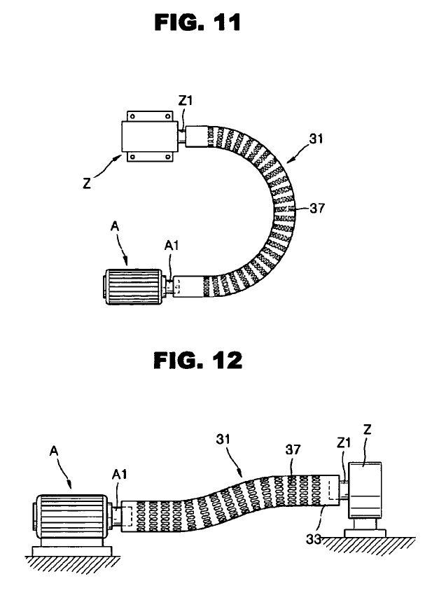

FIGS. 11 and 12 illustrate examples of using the flexible transmission shaft of FIG. 9.

Referring to FIG. 11, the flexible transmission shaft 31 is bent in a semicircular shape to join the drive shaft A1 to the driven shaft Z1 that are parallel to each other. In this state, if the drive source A is operated, the transmission shaft 31 rotates to transmit a torque from the drive source A to the driven load Z.

Referring to FIG. 12, the flexible transmission shaft 31 connects the drive shaft A1 and the driven shaft Z1 that face each other and are misaligned. Since the slit 37 is formed over the entire pipe 33, the transmission shaft 31 connecting the two shafts A1 and Z1 has a curved shape.

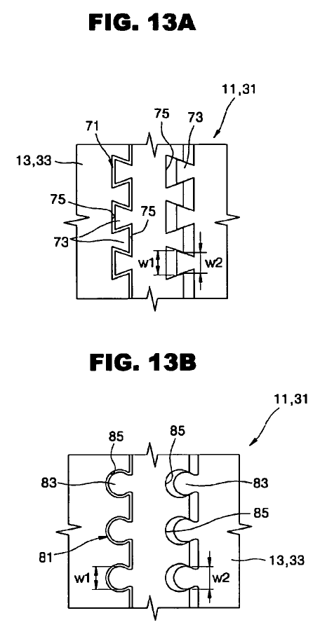

FIGS. 13A and 13B are partial views of the flexible transmission shaft of the present embodiment having slits of different pattern.

As described above, since the slits are processed using a laser cutter or a water jet, the slits can have a different shape. Accordingly, slits having other patterns than that shown in FIGS. 13A and 13b may be formed.

Referring to FIG. 13A, dove tail-shaped slits 71 are formed in the pipe 13 or 33. Trapezoidal recessions 75 are formed at one portion of the pipe 13 or 33 on the basis of the slits 71, and trapezoidal protrusions 73 received in and supported by the trapezoidal recessions 75 are formed at the other portion of the pipe 13 or 33.

Since a maximum width w1 of the protrusions 73 is greater than a width w2 of the recessions 75 at an inlet side, the pipe 13 or 33 is prevented from being disassembled.

Referring to FIG. 13b, C-shaped slits 81 are formed at predetermined intervals. Recessions 85 are formed at one portion of the pipe 13 or 33 on the basis of the slits 81, and protrusions 83 received in and supported by the recessions 85 are formed at the other portion of the pipe 13 or 33. As described in FIG. 13B, since a maximum width w1 of the protrusions 83 is greater than a width w2 of the recessions 85 at an inlet side, the protrusions 83 are prevented from being disengaged from the recessions 85.

While the present invention has been particularly shown and described with reference to preferred embodiments thereof, it will be understood by those of ordinary skill in the art that various changes in form and details may be made therein without departing from the spirit and scope of the present invention as defined by the following claims.

### INDUSTRIAL APPLICABILITY

As described above, since the flexible transmission shaft of the present invention can be bent or curved within a given angle, the flexible transmission shaft can be substituted for, for example, a flexible coupling, a universal joint, or a bevel gear. In addition, the flexible transmission shaft does not require additional mechanical elements to be connected to a shaft, and has a simple structure, light weight, and high torque transmission capability. And the flexible transmission shaft of the present invention can be used, for example, in the automobile industry or aviation industry in cases where torques must be transmitted to different parts hardly accessible due to bundle wires or various manifold.

1. A flexible transmission shaft for transmitting a torque from a drive source to a driven load, the flexible transmission shaft comprising a pipe-shaped shaft, which has one or more slits extending in a circumferential direction of the shaft, each of the slits having two opposed surfaces isolated from each other by the slit, a plurality of protrusions protruding from one of the opposed surfaces, and a plurality of recessions formed in the other one of the opposed surfaces to receive and support the protrusions therein.

2. The flexible transmission shaft of claim 1, wherein the one or more slits circle the shaft such that ends of the one or more slits meet each other, and the one or more slits are formed in a longitudinal direction of the shaft.

3. The flexible transmission shaft of claim 1, wherein the slit extends spirally along the shaft.

4. The flexible transmission shaft of claim 1, wherein a minimum width of an inlet side of the recessions is less than a maximum width of the protrusions so that the protrusions supported in the recessions are prevented from being separated from the recessions.

5. The flexible transmission shaft of claim 1, wherein the opposite surface where the protrusions are formed and the opposite surface where the recessions are formed are spaced by a predetermined distance from each other so that the protrusions inserted into the recessions can move in the recessions.

6. The flexible transmission shaft of claim 1, wherein the slit has a repeated ‘S’ pattern.

7. The flexible transmission shaft of claim 1, wherein the flexible transmission shaft has one end in which a first groove is formed to receive a torque from the drive source and other end in which a second groove is formed to offer the torque to the driven load.

8. The flexible transmission shaft of claim 7, wherein a wrench is inserted in the first groove and a bolt or nut is inserted in the second groove.
